(19) United States
(12) Patent Application Publication
(10) Pub. No.: US 2025/0165235 A1
(43) Pub. Date: May 22, 2025

(54) DATA PROCESSING SYSTEM AND DATA PROCESSING METHOD

(71) Applicant: SEMICONDUCTOR ENERGY LABORATORY CO., LTD., Atsugi-shi (JP)

(72) Inventors: Hiroki INOUE, Atsugi (JP); Toshiki HAMADA, Isehara (JP)

(21) Appl. No.: 18/936,421

(22) Filed: Nov. 4, 2024

(30) Foreign Application Priority Data
Nov. 16, 2023 (JP) 2023-195210

(51) Int. Cl. G06F 8/41

(52) U.S. Cl. CPC G06F 8/436

(57) ABSTRACT

A novel data processing system that is highly convenient, useful, or reliable is provided. The data processing system is composed of the following three components. The first component receives a document written in a programming language, and extracts and provides a syntax error. The second component performs processing using a large language model, and generates a report sentence in accordance with a prompt. The large language model has learned the programming language. The third component performs processing using a database, searches for whether one line includes a registered character string, and if found, replaces the character string with an alternative character string. Moreover, the third component generates a prompt, and verifies each line and generates a report sentence. The system has functions of receiving a document written in the programming language, extracting an error, and generating a report sentence.

### BACKGROUND OF THE INVENTION

### 1. Field of the Invention

One embodiment of the present invention relates to a data processing system and a data processing method.

Note that one embodiment of the present invention is not limited to the above technical field. The technical field of one embodiment of the invention disclosed in this specification and the like relates to an object, a method, or a manufacturing method. One embodiment of the present invention relates to a process, a machine, manufacture, or a composition of matter. Specific examples of the technical field of one embodiment of the present invention disclosed in this specification include a semiconductor device, a display device, a light-emitting device, a power storage device, a memory device, a method for driving any of them, and a method for manufacturing any of them.

### 2. Description of the Related Art

In recent years, language models using neural networks have been actively developed, and a large language model (LLM) has particularly attracted attention. A large language model is a natural language processing model learned using a large amount of data. A large language model enables, for example, an interaction model for responding to user's instructions. In Non-Patent Document 1, Generative Pre-trained Transformer 4 (GPT-4, the registered trademark) is disclosed as a large language model, and ChatGPT is disclosed as an interaction model.

By utilizing a large language model, the capability of a natural language processing model has been significantly increased. Meanwhile, it is difficult to incorporate and operate a language model by oneself in terms of facilities and costs due to hugeness of the language model. Accordingly, a language model provided by external service is generally used.

### REFERENCE

### Non-Patent Document

[Non-Patent Document 1] Yiheng Liu et al., Summary of ChatGPT/GPT-4 Research and Perspective Towards the Future of Large Language Models (Submitted on Apr. 4, 2023, [online] Internet URL: https://arxiv.org/abs/2304.01852

### SUMMARY OF THE INVENTION

One object of one embodiment of the present invention is to provide a novel data processing system that is highly convenient, useful, or reliable. Another object is to provide a novel data processing method that is highly convenient, useful, or reliable. Another object is to provide a novel data processing system, a novel data processing method, or a novel semiconductor device.

Note that the description of these objects does not preclude the presence of other objects. In one embodiment of the present invention, there is no need to achieve all of these objects. Other objects will be apparent from and can be derived from the description of the specification, the drawings, the claims, and the like.
(1) One embodiment of the present invention is a data processing system including a first component, a second component, and a third component.

The first component is configured to receive a document and transfer the document to the third component. Note that the document is written in a programming language.

The first component is configured to receive a report, extract a portion violating syntax of the programming language in the document, and provide it for a user of the data processing system.

The second component is configured to perform processing using a large language model. The large language model has learned the programming language. The second component is configured to generate a report sentence in accordance with a prompt and transfer the report sentence to the third component.

The third component is configured to perform processing using a database.

The database includes a record. The record includes a character string and an alternative character string associated with the character string. The database is configured to send the alternative character string in response to a query specifying the character string, and send the character string in response to a query specifying the alternative character string.

The third component is configured to sequentially read one line from the document. The third component is configured to search for whether the read line includes a character string registered in the database and, when finding the character string, replace the character string of the line with the alternative character string.

The third component is configured to generate the prompt and transfer the prompt to the second component. The prompt includes the line and a template sentence. The template sentence includes an instruction to verify the line and generate the report sentence. Note that when the line violates the syntax, the report sentence includes the line.

The third component is configured to replace the alternative character string included in the report sentence with the character string and then add the report sentence to the report. The third component is configured to transfer the report to the first component.

Accordingly, even when the document written in the programming language includes confidential data, a large language model can be used for verification of the document. Moreover, a large language model can be used to verify the document without leaking confidential data. The syntax of a file input to an electronic circuit simulator, for example, can be verified using a large language model. A line violating the syntax can be extracted and provided from the document. Even an inexperienced designer can efficiently verify the document. As a result, a novel data processing system that is highly convenient, useful, or reliable can be provided.
(2) Another embodiment of the present invention is a data processing system including a first component, a second component, and a third component.

The first component is configured to receive a document and transfer the document to the third component. Note that the document is written in a programming language.

The first component is configured to receive a report, extract a portion violating syntax of the programming language in the document, and provide it for a user of the data processing system.

The second component is configured to perform processing using a large language model. The second component is configured to generate a report sentence in accordance with a prompt and transfer the report sentence to the third component.

The third component is configured to perform processing using a first database.

The first database includes a first record. The first record include a character string and an alternative character string associated with the character string. The first database is configured to send the alternative character string in response to a query specifying the character string. The first database is configured to send the character string in response to a query specifying the alternative character string.

The third component is configured to sequentially read one line from the document. The third component is configured to search for whether the read line includes a character string registered in the first database and, when finding the character string, replace the character string of the line with the alternative character string.

The third component is configured to perform processing using a second database.

The second database includes a second record. The second record includes a reserved word and the syntax associated with the reserved word. The second database is configured to send the syntax in response to a query specifying the reserved word.

The third component is configured to extract a first token from the line. The third component is configured to query whether the first token of the line is registered in the second database and obtain the syntax when the token is the reserved word.

The third component is configured to generate the prompt and transfer the prompt to the second component.

The prompt includes the line, the syntax, and a template sentence. The template sentence includes an instruction to verify the line by using the syntax and generate the report sentence. Note that when the line violates the syntax, the report sentence includes the line.

The third component is configured to replace the alternative character string included in the report sentence with the character string and then add the report sentence to the report. The third component is configured to transfer the report to the first component.
(3) Another embodiment of the present invention is the above-described data processing system in which the first component is configured to receive the report and emphasize a portion violating the syntax in the document.

The template sentence includes the instruction to verify the line by using the syntax and generate the report sentence. The report sentence includes an annotated line. The annotated line includes the line in which predetermined tags are inserted to surround the portion violating the syntax.

Accordingly, for example, a large language model can be used to verify the document written in a programming language that is modified by adding a special function. Moreover, a large language model can be used to verify the document without leaking confidential data. The syntax of a file input to an electronic circuit simulator, for example, can be verified using a large language model. A line violating the syntax can be extracted and provided from the document. A portion violating the syntax can be emphasized and provided. Even an inexperienced designer can efficiently verify the document. As a result, a novel data processing system that is highly convenient, useful, or reliable can be provided.
(4) Another embodiment of the present invention is a data processing method including first to ninth steps.

In the first step, a first component receives a document and transfers the document to a second component. Note that the document is written in a programming language and includes one or more lines.

In the second step, the second component sequentially reads one line from the document. The process proceeds to the third step when a last line of the document has not yet been read out; otherwise, the process proceeds to the eighth step.

In the third step, the second component searches for whether the one line includes a predetermined character string registered in a database. When finding the predetermined character string registered in the database, the second component obtains an alternative character string and replaces the character string of the line with the alternative character string.

Note that the database includes a record, and the record includes the character string and the alternative character string associated with the character string. The database is configured to send the alternative character string in response to a query specifying the character string, and send the character string in response to a query specifying the alternative character string.

In the fourth step, the second component generates a prompt and transfers the prompt to a third component. Note that the prompt includes the line and a template sentence, and the template sentence includes an instruction to verify the line and generate a report sentence. When the line violates syntax, the report sentence includes the line violating the syntax.

In the fifth step, the third component generates the report sentence in accordance with the prompt by using a large language model that has learned the programming language, and transfers the report sentence to the second component,

In the sixth step, when the report sentence includes the alternative character string, the second component replaces the alternative character string with the character string.

In the seventh step, the second component adds the report sentence to a report, and the process proceeds to the second step.

In the eighth step, the second component transfers the report to the first component.

In the ninth step, the first component receives the report and provides the report for a user of the data processing system.

Accordingly, even when the document written in the programming language includes confidential data, a large language model can be used for verification of the document. Moreover, a large language model can be used to verify the document without leaking confidential data. The syntax of a file input to an electronic circuit simulator, for example, can be verified using a large language model. A line violating the syntax can be extracted and provided from the document. Even an inexperienced designer can efficiently verify the document. As a result, a novel data processing method that is highly convenient, useful, or reliable can be provided.
(5) Another embodiment of the present invention is a data processing method including first to tenth steps.

In the first step, a first component receives a document and transfers the document to a second component. Note that the document is written in a programming language and includes one or more lines.

In the second step, the second component sequentially reads one line from the document. The process proceeds to the third step when a last line of the document has not yet been read out; otherwise, the process proceeds to the ninth step.

In the third step, the second component searches for whether the one line includes a predetermined character string registered in a first database. When finding the predetermined character string registered in the first database, the second component obtains an alternative character string and replaces the character string of the line with the alternative character string.

Note that the first database includes a first record, and the first record includes the character string and the alternative character string associated with the character string. The first database is configured to send the alternative character string in response to a query specifying the character string, and send the character string in response to a query specifying the alternative character string.

In the fourth step, the second component queries whether a first token of the line is registered in a second database, and obtains syntax when the token is a reserved word registered in the second database.

Note that the second database includes a second record, and the second record includes the reserved word and the syntax associated with the reserved word. The second database is configured to send the syntax in response to a query specifying the reserved word.

In the fifth step, the second component generates a prompt and transfers the prompt to a third component. Note that the prompt includes the line, the syntax, and a template sentence, and the template sentence includes an instruction to verify the line and generate a report sentence. When the line violates the syntax, the report sentence includes an annotated line. The annotated line includes predetermined tags inserted to surround a portion violating the syntax.

In the sixth step, the third component generates the report sentence in accordance with the prompt by using a large language model, and transfers the report sentence to the second component.

In the seventh step, when the report sentence includes the alternative character string, the second component replaces the alternative character string with the character string.

In the eighth step, the second component adds the report sentence to a report, and the process proceeds to the second step.

In the ninth step, the second component transfers the report to the first component.

In the tenth step, the first component receives the report, emphasizes the portion violating the syntax, and provides the report for a user of the data processing system.

Accordingly, for example, a large language model can be used to verify the document written in a programming language that is modified by adding a special function. Moreover, a large language model can be used to verify the document without leaking confidential data. The syntax of a file input to an electronic circuit simulator, for example, can be verified using a large language model. A line violating the syntax can be extracted and provided from the document. A portion violating the syntax can be emphasized and provided. Even an inexperienced designer can efficiently verify the document. As a result, a novel data processing method that is highly convenient, useful, or reliable can be provided.

Although a block diagram in drawings attached to this specification shows components classified based on their functions in independent blocks, it is difficult to classify actual components completely on the basis of their functions, and one component can have a plurality of functions.

One embodiment of the present invention can provide a novel data processing system that is highly convenient, useful, or reliable. Another embodiment of the present invention can provide a novel data processing method that is highly convenient, useful, or reliable. Furthermore, a novel data processing system can be provided. Moreover, a novel data processing method can be provided.

Note that the description of these effects does not preclude the existence of other effects. One embodiment of the present invention does not necessarily have all of these effects. Other effects will be apparent from and can be derived from the description of the specification, the drawings, the claims, and the like.

### BRIEF DESCRIPTION OF THE DRAWINGS

In the accompanying drawings:

FIG. 1 illustrates a structure of a data processing system of an embodiment;

FIGS. 2A and 2B illustrate structures for a data processing system of an embodiment;

FIGS. 3A to 3D illustrate structures for a data processing system of an embodiment;

FIG. 4 illustrates a structure of a data processing system of an embodiment;

FIG. 5 illustrates a data processing method of an embodiment; and

FIG. 6 illustrates a data processing method of an embodiment.

### DETAILED DESCRIPTION OF THE INVENTION

A data processing system of one embodiment of the present invention includes a first component, a second component, and a third component. The first component has functions of receiving a document and transferring the document to the third component. The document is written in a programming language. The first component has functions of receiving a report and extracting and providing a portion violating syntax of the programming language in the document. The second component has a function of performing processing using a large language model. The large language model has learned the programming language. The second component has functions of generating a report sentence in accordance with a prompt and transferring the report sentence to the third component. The third component has a function of performing processing using a first database. The first database includes a first record. The first record includes a character string and an alternative character string associated with the character string. The first database has functions of sending the alternative character string in response to a query specifying the character string, and sending the character string in response to a query specifying the alternative character string. The third component has a function of sequentially reading one line from the document. The third component has functions of searching for whether the read line includes a character string registered in the first database and, when finding the character string, replacing the character string of the line with the alternative character string. The third component has functions of generating the prompt and transferring the prompt to the second component. The prompt includes the line and a template sentence. The template sentence includes an instruction for verifying the line and generating the report sentence. When the line violates the syntax, the report sentence includes the line. The third component has a function of replacing the alternative character string included in the report sentence with the character string and then adding the report sentence to the report. The third component has a function of transferring the report to the first component.

Accordingly, even when the document written in the programming language includes confidential data, a large language model can be used for verification of the document. Moreover, a large language model can be used to verify the document without leaking confidential data. The syntax of a file input to an electronic circuit simulator, for example, can be verified using a large language model. A line violating the syntax can be extracted and provided from the document. Even an inexperienced designer can efficiently verify the document. As a result, a novel data processing system that is highly convenient, useful, or reliable can be provided.

Embodiments will be described in detail with reference to the drawings. Note that the present invention is not limited to the following description, and it will be readily appreciated by those skilled in the art that modes and details of the present invention can be modified in various ways without departing from the spirit and scope of the present invention. Therefore, the present invention should not be construed as being limited to the description in the following embodiments. Note that in structures of the invention described below, the same portions or portions having similar functions are denoted by the same reference numerals in different drawings, and the description thereof is not repeated.

### Embodiment 1

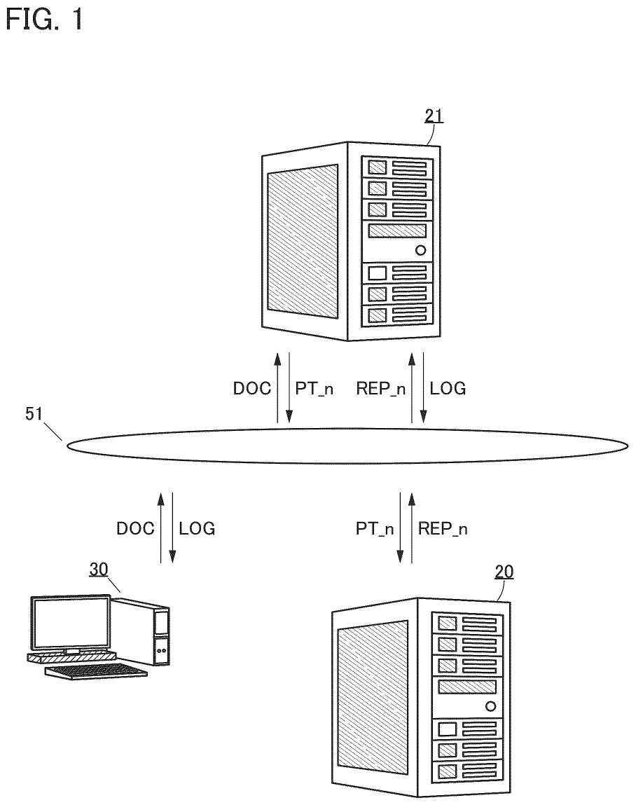

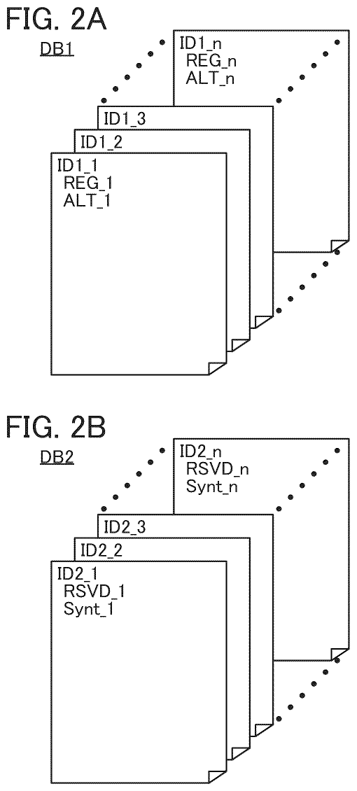

In this embodiment, a data processing system of one embodiment of the present invention will be described with reference to FIG. 1, FIGS. 2A and 2B, FIGS. 3A to 3D, and FIG. 4.

FIG. 1 illustrates a structure of the data processing system of one embodiment of the present invention.

FIGS. 2A and 2B are schematic diagrams each illustrating a structure of a database used by the data processing system of one embodiment of the present invention.

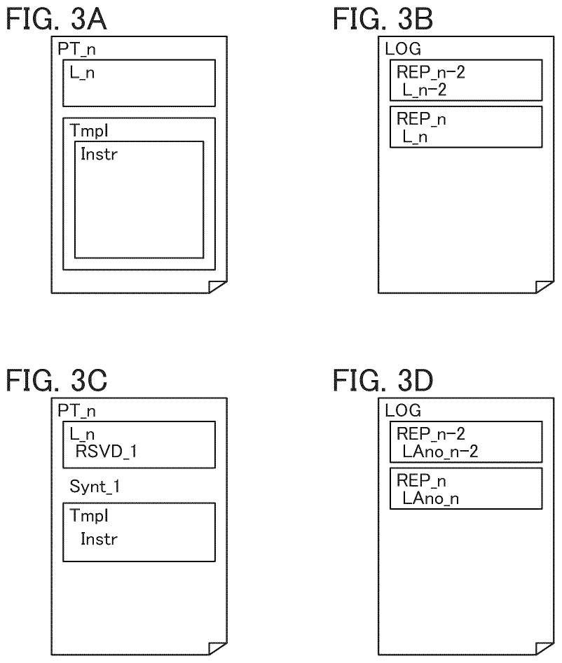

FIG. 3A is a schematic diagram illustrating a structure of a prompt used by the data processing system of one embodiment of the present invention, and FIG. 3B is a schematic diagram illustrating a structure of a report generated by the data processing system. FIG. 3C is a schematic diagram illustrating a structure of a prompt that is different from that in FIG. 3A and used by the data processing system of one embodiment of the present invention, and FIG. 3D is a schematic diagram illustrating a structure of a report that is different from that in FIG. 3B and generated by the data processing system.

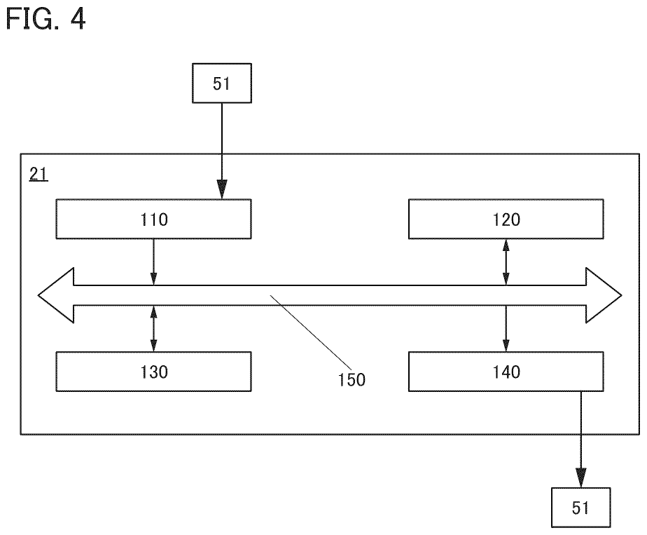

FIG. 4 is a block diagram illustrating a structure of a data processing device that can be used for the data processing system of one embodiment of the present invention.

### <Structure Example 1 of Data Processing System>

A data processing system described in this embodiment includes a component 30, a component 20, and a component 21 (see FIG. 1).

### <<Structure Example 1 of Component 30>>

The component 30 has functions of receiving a document DOC and transferring the document DOC to the component 21.

Note that the document DOC is written in a programming language Lang. The document DOC includes one or more lines. For example, the document DOC can be divided into a plurality of lines by syntactic analysis process. One line includes, for example, one instruction sentence and a description describing one connection relation.

For example, in the case where the document DOC is described in a language used for an operation simulator for an electronic circuit, the document DOC includes data on connection between circuit elements, data on characteristics of the circuit elements, a model definition, simulation conditions, and the like. For example, in the case where Simulation Program with Integrated Circuit Emphasis (SPICE) is used for the operation simulator for an electronic circuit, text based on the SPICE syntax can be used for the document DOC.

The component 30 also has functions of receiving a report LOG created by the component 21 and providing a user of the data processing system with the report LOG. Note that a portion that is included in the document DOC and violates the syntax of the programming language Lang is extracted in the report LOG. In other words, the data processing system described in this embodiment has functions of receiving the document DOC written in the programming language Lang, verifying whether the document DOC violates the syntax of the programming language Lang, and extracting a portion that violates the syntax of the programming language Lang.

### <<Structure Example 1 of Component 20>>

The component 20 has a function of performing processing using a large language model (LLM). Note that the large language model has learned the programming language Lang. Alternatively, an existing large language model may be made to additionally learn the programming language Lang. By learning the programming language Lang, the large language model can verify whether one line violates the syntax of the programming language Lang.

For example, the component 20 can perform processing using a language model Bidirectional Encoder Representations from Transformers (BERT). For another example, the component 20 can perform processing using GPT-3, GPT-3.5, GPT-4, Language Model for Dialogue Applications (LaMDA), Pathways Language Model (PaLM), Llama2, ALBERT, XLNet, or the like.

The component 20 also has functions of generating a report sentence REP_n in accordance with a prompt PT_n and transferring the report sentence REP_n to the component 21.

### <<Structure Example 1 of Component 21>>

The component 21 has a function of performing processing using a database DB1.

### [Structure Example of Database DB1]

The database DB1 includes a record ID1_1, a record ID1_2, and a record ID1_n (see FIG. 2A). For example, the record ID1_1 includes a character string REG_1 and an alternative character string ALT_1 associated with the character string REG_1. The record ID1_n includes a character string REG_n and an alternative character string ALT_n. For example, the character string REG_1 is a description including confidential data, and the alternative character string ALT_1 is a description in which the confidential data is hidden. Specifically, the character string REG_1 is a description including data on an electronic circuit that the user of the data processing system of one embodiment of the present invention does not intend to disclose, data on an electronic circuit that an organization to which the user belongs does not intend to disclose, or data that cannot be disclosed in accordance with a contract with a client. If the document DOC includes a description including confidential data in the case of using external service that provides a language model, the possibility of leaking the confidential data increases. Replacing the description including confidential data with the alternative character string ALT_1 can reduce the possibility of leaking the confidential data.

Examples of confidential data include the case where a file path where a library provided from a client is stored is confidential data, the case where a model name that specifies a model provided from a client is confidential data, and the case where a description of a subcircuit is confidential data.

The component 21 may successively generate the alternative character string ALT_1, for example. The alternative character string ALT_1 to replace the character string REG_1 can be determined in advance. Note that when the alternative character string ALT_1 and the character string REG_1 are paired and recorded, the alternative character string ALT_1 can be replaced with the character string REG_1 again.

The database DB1 has a function of sending the alternative character string ALT_1 in response to a query specifying the character string REG_1.

The database DB1 also has a function of sending the character string REG_1 in response to a query specifying the alternative character string ALT_1. Note that the relation between the character string REG_1 and the alternative character string ALT_1 may be a one-to-one relation or a one-to-many relation as long as the alternative character string ALT_1 can be replaced with the character string REG_1 again.

### <<Structure Example 2 of Component 21>>

The component 21 has a function of sequentially reading one line from the document DOC. Note that in the case of a large-scale integrated circuit, a file input to an operation simulator for an electronic circuit may have a few million lines, for example. It is extremely difficult to find a description with a syntax error in such a long document DOC. Furthermore, part of a long document can be used as the document DOC. For example, the document DOC can include descriptions written by a human while getting rid of descriptions made by electronic design automation (EDA) tools, which are unlikely to provide descriptions with incorrect syntax. In addition, a plurality of lines may be read out to make the component 20 verify the syntax of the plurality of lines at a time.

The component 21 searches for whether a read line L_n includes a character string registered in the database DB1. The component 21 has a function of, when finding the character string REG_1, for example, replacing the character string REG_1 of the line L_n with the alternative character string ALT_1.

### <<Structure Example 3 of Component 21>>

The component 21 has functions of generating the prompt PT_n and transferring the prompt PT_n to the component 20 (see FIG. 1). Note that the prompt PT_n includes the line L_n and a template sentence Tmpl (see FIG. 3A).

### [Structure Example 1 of Template Sentence Tmpl]

The template sentence Tmpl includes an instruction Instr for verifying whether the line L_n violates the syntax of the programming language and generating the report sentence REP_n.

For example, the template sentence Tmpl can be “Check the syntax of the following sentence. Comments are not required.” and the prompt PT_n can be the template sentence Tmpl followed by the line L_n.

### [Structure Example 1 of Report Sentence REP_n]

In the case where the line L_n violates the syntax, the report sentence REP_n includes the line L_n (see FIG. 3B). Note that in the case where the line L_n conforms to the syntax, the report sentence REP_n may be a null character (null).

### <<Structure Example 4 of Component 21>>

The component 21 has a function of replacing the alternative character string ALT_1 included in the report sentence REP_n with the character string REG_1 and then adding the report sentence REP_n to the report LOG. For example, in the case where a description that violates the syntax is found in a line L_n−2 and the line L_n, a report sentence REP_n−2 and the report sentence REP_n after the report sentence REP_n−2 are added, so that the report LOG shown in FIG. 3B is created. Note that the report sentences may be sequentially added to an empty file used as the report LOG.

The component 21 has a function of transferring the report LOG to the component 30.

Accordingly, even when the document DOC written in the programming language Lang includes confidential data, a large language model can be used for verification of the document DOC. Moreover, a large language model can be used to verify the document DOC without leaking confidential data. The syntax of a file input to an electronic circuit simulator, for example, can be verified using a large language model. The line L_n that violates the syntax can be extracted and provided from the document DOC. Even an inexperienced designer can efficiently verify the document DOC. As a result, a novel data processing system that is highly convenient, useful, or reliable can be provided.

### <Structure Example 2 of Data Processing System>

Structure example 2 of data processing system is different from Structure example 1 of data processing system in that the component 21 has a function of performing processing using a database DB2, that the component 21 has a function of generating the prompt PT_n including predetermined syntax, that the component 20 has a function of generating an annotated line LAno_n, and that the component 30 has a function of emphasizing a portion that violates the syntax. Here, portions different from those in Structure example 1 will be described in detail, and the above description is referred to for similar portions.

### <<Structure Example 5 of Component 21>>

The component 21 has a function of performing processing using the database DB2.

### [Structure Example of Database DB2]

The database DB2 includes a record ID2_1, a record ID2_2, and a record ID2_n (see FIG. 2B). For example, the record ID2_1 includes a reserved word RSVD_1 and syntax Synt_1 associated with the reserved word RSVD_1. The record ID2_n includes a reserved word RSVD_n and syntax Synt_n associated with the reserved word RSVD_n. Specifically, in the case where SPICE is used for an operation simulator for an electronic circuit, a command, a circuit element, a model, or the like can be used as the reserved word RSVD_1.

For example, “V” is a reserved word for a power supply. A description “V1 VDD GND DC 1V” according to the syntax, for example, can represent a DC voltage source V1 that supplies a node VDD with a constant potential of 1 V relative to a node GND.

In addition, “C1” is a reserved word for a capacitor. A description “C1 VDD GND 1pf” according to the syntax, for example, can represent a 1-pF capacitor provided between the node VDD and the node GND.

Moreover, “.SUBCKT” and “.ENDS” are reserved words used for describing a subcircuit model. According to the syntax, an inverter can be represented by a description in the following paragraph, for example.
“.SUBCKT INV I O VDD GND
MP O I VDD VDD PMOS L=1u W=1u
MN O I GND GND NMOS L=1u W=1u
.ENDS”

Furthermore, “.TRAN” is a reserved word for transient analysis. A description “.TRAN 100p 1n” according to the syntax, for example, can represent an instruction to perform transient analysis every 100 ps for a period up to 1 ns.

In addition, “.TEMP” is a reserved word for temperature analysis. A description “.TEMP 27” according to the syntax, for example, enables the analysis temperature to be set to 27° C.

The database DB2 has a function of sending the syntax Synt_1 in response to a query specifying the reserved word RSVD_1.

### <<Structure Example 6 of Component 21>>

The component 21 has a function of extracting a first token from the line L_n. Note that the first token is from the first character to a character immediately before a first delimiter of the line L_n. For example, a blank (a space) can be used as a delimiter. In the case where the document DOC is written in the programming language Lang, the probability that the first token is a reserved word is high; thus, the description of the line L_n is also highly likely to follow the syntax defined by the reserved word.

The component 21 has functions of querying whether the first token of the line L_n is registered in the database DB2 and obtaining the syntax Synt_1 when the token is the reserved word RSVD_1.

The prompt PT_n includes the line L_n, the syntax Synt_1, and the template sentence Tmpl (see FIG. 3C).

### [Structure Example 2 of Template Sentence Tmpl]

The template sentence Tmpl includes the instruction Instr for verifying whether the line L_n violates the syntax with the use of the syntax Synt_1 and generating the report sentence REP_n.

For example, the template sentence Tmpl can be “Check the following sentence by reference to the following syntax. If there is a portion that violates the syntax, insert the tag <mark> and the tag </mark> to surround the portion that violates the syntax. Comments are not required.” The prompt PT_n can be the template sentence Tmpl followed by the syntax Synt_1 and the line L_n.

### [Structure Example 2 of Report Sentence REP_n]

The report sentence REP_n includes the annotated line LAno_n (see FIG. 3D). Note that the annotated line LAno_n includes the line L_n in which predetermined tags are inserted to surround a portion that violates the syntax Synt_1. For example, the tag <mark> and the tag </mark> can be used.

### <<Structure Example 2 of Component 30>>

The component 30 has functions of receiving the report LOG and emphasizing a portion that violates the syntax Synt_1 in the document DOC. For example, the portion that violates the syntax is highlighted, inverted, or underlined.

Accordingly, for example, a large language model can be used to verify the document DOC written in the programming language Lang that is modified by adding a special function. Moreover, a large language model can be used to verify the document DOC without leaking confidential data. The syntax of a file input to an electronic circuit simulator, for example, can be verified using a large language model. The line L_n that violates the syntax can be extracted and provided from the document DOC. A portion that violates the syntax Synt_1 can be emphasized and provided. Even an inexperienced designer can efficiently verify the document DOC. As a result, a novel data processing system that is highly convenient, useful, or reliable can be provided.

### <Structure Example 3 of Data Processing System>

The data processing system described in this embodiment includes the component 30, the component 21, and the component 20 (see FIG. 1).

For example, the data processing system of one embodiment of the present invention can be composed of a data processing device that serves the functions of the component 30, a data processing device that serves the functions of the component 21, and a data processing device that serves the functions of the component 20. Note that the number of data processing devices constituting the data processing system of one embodiment of the present invention is one or more. As another example, the data processing system of one embodiment of the present invention can be composed of a plurality of data processing devices that are connected to each other via a network 51.

When the data processing system of one embodiment of the present invention is composed of a plurality of data processing devices, loads related to data processing can be split.

### <<Structure Example 1 of Data Processing Device>>

A data processing device with Structure example 1 described in this embodiment can be used for the component 30. The data processing device with Structure example 1 can be referred to as a client computer or the like. For example, a desktop computer can be used as the component 30.

The data processing device with Structure example 1 can receive data input by the user of the data processing system of one embodiment of the present invention. Moreover, the data processing device with Structure example 1 can provide the user with data output from the data processing system of one embodiment of the present invention.

The user of the data processing system of one embodiment of the present invention can access the data processing system through dedicated application software or a web browser, for example. Accordingly, the user can enjoy service using the data processing system of one embodiment of the present invention.

### <<Structure Example 2 of Data Processing Device>>

A data processing device with Structure example 2 described in this embodiment can be used for the component 21. For example, a workstation, a server computer, or a supercomputer can be used as the component 21.

The data processing device with Structure example 2 preferably has a function of a parallel computer. By using the data processing device as a parallel computer, large-scale computation necessary for artificial intelligence (AI) learning and inference can be performed, for example.

The data processing device with Structure example 2 can perform processing using a natural language processing model using AI.

For example, it is possible to execute processing using a natural language model (natural language processing) such as Bidirectional Encoder Representations from Transformers (BERT), Text-to-Text Transfer Transformer (T5), GPT-3, GPT-3.5, GPT-4, Language Model for Dialogue Applications (LaMDA), Pathways Language Model (PaLM), or Llama2.

### <<Structure Example 3 of Data Processing Device>>

For example, a data processing device with Structure example 3 described in this embodiment can be used for the component 20. Note that the component 20 has a larger scale and higher computational capability than the component 21. For example, a large computer such as a server computer or a supercomputer can be used as the component 20.

The data processing device with Structure example 3 preferably has a function of a parallel computer. By using the data processing device as a parallel computer, large-scale computation necessary for AI learning and inference can be performed, for example.

The data processing device with Structure example 3 can perform processing using a natural language processing model using AI. In particular, the data processing device with Structure example 3 can execute processing using a general-purpose language processing model capable of performing various natural language processing tasks.

For example, it is possible to execute processing using a natural language model (natural language processing) such as BERT, T5, GPT-3, GPT-3.5, GPT-4, LaMDA, PaLM, or Llama2. It is particularly preferable to execute processing using GPT-4. For example, processing using a large language model that is larger in scale than a conventional natural language model can achieve more natural text generation, interaction, or the like.

Note that a provider that provides service with the use of the data processing system of one embodiment of the present invention does not necessarily have to own the data processing device with Structure example 3. For example, the service provider can use part of the service which another company or the like provides using the data processing device with Structure example 3.

### <<Structure Example of Network 51>>

The network 51 that can be used for the data processing system of one embodiment of the present invention can connect a plurality of data processing devices. Thus, the plurality of data processing devices connected to each other can transmit and receive data to/from each other. Furthermore, loads related to data processing can be split.

Note that for wireless communication, it is possible to use, as a communication protocol or a communication technology, a communication standard such as the fourth-generation mobile communication system (4G), the fifth-generation mobile communication system (5G), or the sixth-generation mobile communication system (6G), or a communication standard developed by IEEE, such as Wi-Fi (registered trademark) or Bluetooth (registered trademark).

For example, a local network can be used as the network 51. An intranet or an extranet can also be used as the network 51. For another example, a personal area network (PAN), a local area network (LAN), a campus area network (CAN), a metropolitan area network (MAN), a wide area network (WAN), or a global area network (GAN) can be used as the network 51.

For another example, a global network can be used as the network 51. Specifically, the Internet, which is an infrastructure of the World Wide Web (WWW), can be used.

The provider that provides service with the use of the data processing system of one embodiment of the present invention can provide service using the data processing method of one embodiment of the present invention via the network 51, for example.

Note that when the data processing system of one embodiment of the present invention is built in a local network, the possibility of leaking confidential data can be lower than that in the case of using the Internet, for example.

### <<Structure Example 4 of Data Processing Device>>

The data processing device that can be used for the data processing system of one embodiment of the present invention includes, for example, an input unit 110, a memory unit 120, a processing unit 130, an output unit 140, and a transmission path 150 (see FIG. 4).

Although the block diagram in drawings attached to this specification illustrates components classified by their functions in independent blocks, it is difficult to classify actual components completely on the basis of their functions, and one component can have a plurality of functions. For example, part of the processing unit 130 may function as the input unit 110. In addition, one function can be involved in a plurality of components. For example, processing executed by the processing unit 130 may be executed in different servers depending on processing content.

### [Input Unit 110]

The input unit 110 can receive data from the outside of the data processing device. For example, the input unit 110 receives data via the network 51.

The input unit 110 supplies the received data to one or both of the memory unit 120 and the processing unit 130 via the transmission path 150.

### [Memory Unit 120]

The memory unit 120 has a function of storing a program to be executed by the processing unit 130. The memory unit 120 may have a function of storing data (e.g., an arithmetic result, an analysis result, and an inference result) generated by the processing unit 130, data received by the input unit 110, and the like.

The memory unit 120 may include a database. The data processing device may include a database different from that of the memory unit 120. The data processing device may have a function of extracting data from a database that is placed outside the memory unit 120, the data processing device, or the data processing system. The data processing device may have a function of extracting data from both of its own database and an external database.

One or both of a storage and a file server can be used as the memory unit 120. In addition, a database in which a path of a file stored in the file server is recorded can be used as the memory unit 120.

The memory unit 120 includes at least one of a volatile memory and a nonvolatile memory. Examples of the volatile memory include a dynamic random access memory (DRAM) and a static random access memory (SRAM). Examples of the nonvolatile memory include a resistive random access memory (ReRAM, also referred to as a resistance-change memory), a phase-change random access memory (PRAM), a ferroelectric random access memory (FeRAM), a magnetoresistive random access memory (MRAM, also referred to as a magnetoresistive memory), and a flash memory. The memory unit 120 may include at least one of a NOSRAM (registered trademark) and a DOSRAM (registered trademark). The memory unit 120 may include a recording media drive. Examples of the recording media drive include a hard disk drive (HDD) and a solid state drive (SSD).

Note that “NOSRAM” is an abbreviation for “nonvolatile oxide semiconductor random access memory (RAM)”. The NOSRAM refers to a memory in which a two-transistor (2T) or three-transistor (3T) gain cell is used as a memory cell and each transistor includes a metal oxide in its channel formation region (such a transistor is also referred to as an OS transistor). The OS transistor has an extremely low current that flows between a source and a drain in an off state, that is, an extremely low leakage current. The NOSRAM can be used as a nonvolatile memory by retaining electric charge corresponding to data in memory cells with the use of the characteristic of extremely low leakage current. In particular, the NOSRAM is capable of reading retained data without destruction (non-destructive reading), and thus is suitable for arithmetic processing in which only data reading operations are repeated many times. The NOSRAM can have large data capacity when being stacked in layers; accordingly, when the NOSRAM is used in a large-scale cache memory, a main memory, or a storage memory, the performance of the semiconductor device can be improved.

The DOSRAM is an abbreviation for “dynamic oxide semiconductor RAM” and refers to a RAM including a one-transistor (1T) and one-capacitor (1C) memory cell. The DOSRAM is a DRAM formed using an OS transistor and temporarily stores data sent from the outside. The DOSRAM is a memory utilizing low off-state current of an OS transistor.

In this specification and the like, a metal oxide means an oxide of a metal in a broad sense. Metal oxides are classified into an oxide insulator, an oxide conductor (including a transparent oxide conductor), an oxide semiconductor (also simply referred to as an OS), and the like. For example, in the case where a metal oxide is used in a semiconductor layer of a transistor, the metal oxide is referred to as an oxide semiconductor in some cases.

The metal oxide included in the channel formation region preferably includes indium (In). When the metal oxide included in the channel formation region is a metal oxide including indium, the carrier mobility (electron mobility) of the OS transistor is high. The metal oxide included in the channel formation region is preferably an oxide semiconductor including an element M. The element M is preferably at least one of aluminum (Al), gallium (Ga), and tin (Sn). Other elements that can be used as the element M are boron (B), silicon (Si), titanium (Ti), iron (Fe), nickel (Ni), germanium (Ge), yttrium (Y), zirconium (Zr), molybdenum (Mo), lanthanum (La), cerium (Ce), neodymium (Nd), hafnium (Hf), tantalum (Ta), tungsten (W), and the like. Note that a combination of two or more of the above elements may be used as the element M. The element M is, for example, an element that has high bonding energy with oxygen. The element M is, for example, an element that has higher bonding energy with oxygen than indium does. The metal oxide included in the channel formation region is preferably a metal oxide including zinc (Zn). The metal oxide including zinc is easily crystallized in some cases.

The metal oxide included in the channel formation region is not limited to the metal oxide including indium. The metal oxide in the channel formation region may be, for example, a metal oxide that does not include indium and includes any of zinc, gallium, and tin (e.g., zinc tin oxide or gallium tin oxide).

### [Processing Unit 130]

The processing unit 130 has a function of performing processing such as arithmetic operation, analysis, and inference with the use of data supplied from one or both of the input unit 110 and the memory unit 120. The processing unit 130 can supply generated data (e.g., an arithmetic result, an analysis result, or an inference result) to one or both of the memory unit 120 and the output unit 140.

The processing unit 130 has a function of obtaining data from the memory unit 120. The processing unit 130 may have a function of storing or registering data in the memory unit 120.

The processing unit 130 can include, for example, an arithmetic circuit. The processing unit 130 can include, for example, a central processing unit (CPU). The processing unit 130 can also include a graphics processing unit (GPU).

The processing unit 130 may include a microprocessor such as a digital signal processor (DSP). The microprocessor may be configured with a programmable logic device (PLD) such as a field programmable gate array (FPGA) or a field programmable analog array (FPAA). The processing unit 130 may include a quantum processor. With a processor, the processing unit 130 can interpret and execute instructions from various kinds of programs to process various kinds of data and control programs. The programs to be executed by the processor are stored in at least one of the memory unit 120 and a memory region of the processor.

The processing unit 130 may include a main memory. The main memory includes at least one of a volatile memory such as a random access memory (RAM) and a nonvolatile memory such as a read only memory (ROM). The main memory may include at least one of the above-described NOSRAM and DOSRAM.

For example, a DRAM, an SRAM, or the like is used as the RAM, and a virtual memory space is assigned and utilized as a working space of the processing unit 130. An operating system, an application program, a program module, program data, a look-up table, and the like that are stored in the memory unit 120 are loaded into the RAM for execution. The data, program, and program module that are loaded into the RAM are each directly accessed and operated by the processing unit 130.

The ROM can store a basic input/output system (BIOS), firmware, and the like for which rewriting is not needed. Examples of the ROM include a mask ROM, a one-time programmable read only memory (OTPROM), and an erasable programmable read only memory (EPROM). Examples of the EPROM include an ultraviolet erasable programmable read only memory (UV-EPROM) that can erase stored data by irradiation with ultraviolet rays, an electrically erasable programmable read only memory (EEPROM), and a flash memory.

The processing unit 130 can include one or both of an OS transistor and a transistor including silicon in its channel formation region (a Si transistor).

The processing unit 130 preferably includes an OS transistor. Since the OS transistor has an extremely low off-state current, a long data retention period can be ensured with the use of the OS transistor as a switch for retaining electric charge (data) that has flowed into a capacitor functioning as a memory element. When this feature is imparted to at least one of a register and a cache memory included in the processing unit, the processing unit can be operated only when needed, and otherwise can be off while data processed immediately before turning off the processing unit is stored in the memory element. In other words, normally-off computing is possible, and power consumption of the data processing system can be reduced.

The data processing device preferably uses AI for at least part of its processing.

In particular, the data processing device preferably uses an artificial neural network (ANN; hereinafter also simply referred to as a neural network). The neural network is constructed with circuits (hardware) or programs (software).

In this specification and the like, the neural network indicates a general model having the capability of solving problems, which is modeled on a biological neural network and determines the connection strength of neurons by learning. The neural network includes an input layer, a middle layer (hidden layer), and an output layer.

In the description of the neural network in this specification and the like, determining a connection strength of neurons (also referred to as weight coefficients) from the existing data is referred to as “learning” in some cases.

In this specification and the like, drawing a new conclusion from a neural network formed with the connection strength obtained by learning is referred to as “inference” in some cases.

### [Output Unit 140]

The output unit 140 can output at least one of an arithmetic result, an analysis result, and an inference result in the processing unit 130 to the outside of the data processing device. For example, the output unit 140 can transmit data via the network 51.

### [Transmission Path 150]

The transmission path 150 has a function of transmitting data. Data transmission and reception between the input unit 110, the memory unit 120, the processing unit 130, and the output unit 140 can be performed via the transmission path 150.

Note that this embodiment can be combined with the other embodiment in this specification as appropriate.

### Embodiment 2

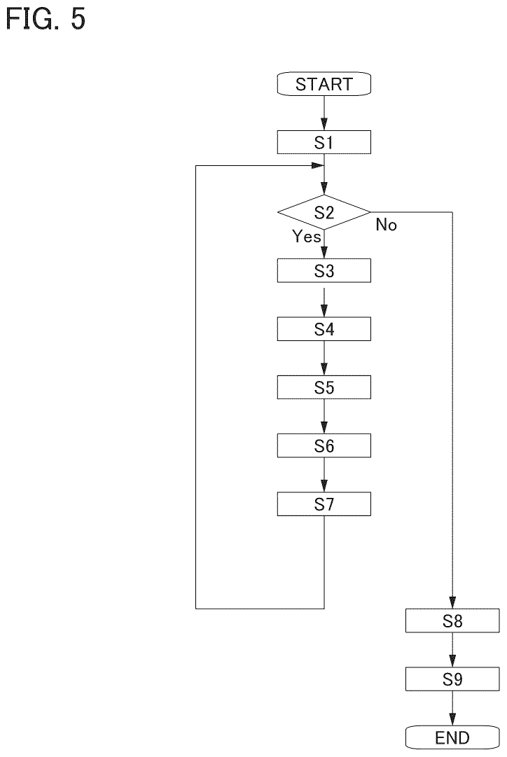

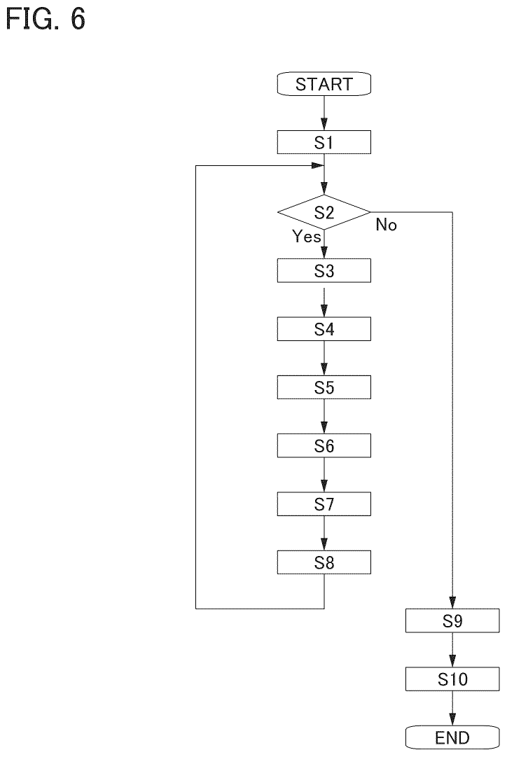

In this embodiment, a data processing method of one embodiment of the present invention will be described with reference to FIG. 5 and FIG. 6.

FIG. 5 illustrates a data processing method of one embodiment of the present invention.

FIG. 6 illustrates another data processing method of one embodiment of the present invention.

### <Example 1 of Data Processing Method>

A data processing method of Example 1 described in this embodiment includes Step S1 to Step S9 (see FIG. 5).

### [Step S1]

In Step S1, the component 30 receives the document DOC and transfers the document DOC to the component 21. Note that the document DOC is written in the programming language Lang, and the document DOC includes one or more lines.

### [Step S2]

In Step S2, the component 21 sequentially reads one line from the document DOC. In the case where the last line of the document DOC has not yet been read out, the process proceeds to Step S3; otherwise, the process proceeds to Step S8. Alternatively, a plurality of lines may be read out to verify the syntax of the plurality of lines at a time.

### [Step S3]

In Step S3, the component 21 searches for whether the read one read line L_n includes a predetermined character string registered in the database DB1.

In the case where the predetermined character string REG_1 registered in the database DB1 is found, the alternative character string ALT_1 is obtained and the character string REG_1 included in the line L_n is replaced with the alternative character string ALT_1. For example, the character string REG_1 is a description including confidential data, and the alternative character string ALT_1 is a description in which the confidential data is hidden.

Note that the database DB1 includes the record ID1_1, and the record ID1_1 includes the character string REG_1 and the alternative character string ALT_1 associated with the character string REG_1 (see FIG. 2A).

The database DB1 has a function of sending the alternative character string ALT_1 in response to a query specifying the character string REG_1. The database DB1 also has a function of sending the character string REG_1 in response to a query specifying the alternative character string ALT_1.

### [Step S4]

In Step S4, the component 21 generates the prompt PT_n and transfers the prompt PT_n to the component 20.

The prompt PT_n includes the line L_n and the template sentence Tmpl. The template sentence Tmpl includes the instruction Instr for verifying the line L_n and generating the report sentence REP_n (see FIG. 3A). In the case where the line L_n violates the syntax, the report sentence REP_n includes the line L_n that violates the syntax (see FIG. 3B).

### [Step S5]

In Step S5, the component 20 generates the report sentence REP_n in accordance with the prompt PT_n by using a large language model that has learned the programming language Lang, and transfers the report sentence REP_n to the component 21.

### [Step S6]

In Step S6, when the report sentence REP_n includes the alternative character string ALT_1, the component 21 replaces the alternative character string ALT_1 with the character string REG_1.

### [Step S7]

In Step S7, the component 21 adds the report sentence REP_n to the report LOG, and the process proceeds to Step S2.

### [Step S8]

In Step S8, the component 21 transfers the report LOG to the component 30.

### [Step S9]

In Step S9, the component 30 receives the report LOG and provides the user of the data processing system with the report LOG.

Accordingly, even when the document DOC written in the programming language Lang includes confidential data, a large language model can be used for verification of the document DOC. Moreover, a large language model can be used to verify the document DOC without leaking confidential data. The syntax of a file input to an electronic circuit simulator, for example, can be verified using a large language model. The line L_n that violates the syntax can be extracted and provided from the document DOC. Even an inexperienced designer can efficiently verify the document DOC. As a result, a novel data processing method that is highly convenient, useful, or reliable can be provided.

### <Example 2 of Data Processing Method>

A data processing method of Example 2 described in this embodiment includes Step S1 to Step S10 (see FIG. 6).

### [Step S1]

In Step S1, the component 30 receives the document DOC and transfers the document DOC to the component 21. Note that the document DOC is written in the programming language Lang, and the document DOC includes one or more lines.

### [Step S2]

In Step S2, the component 21 sequentially reads one line from the document DOC. In the case where the last line of the document DOC has not yet been read out, the process proceeds to Step S3; otherwise, the process proceeds to Step S9. Alternatively, a plurality of lines may be read out to verify the syntax of the plurality of lines at a time.

### [Step S3]

In Step S3, the component 21 searches for whether the read one read line L_n includes a predetermined character string registered in the database DB1.

In the case where the predetermined character string REG_1 registered in the database DB1 is found, the alternative character string ALT_1 is obtained and the character string REG_1 in the line L_n is replaced with the alternative character string ALT_1. For example, the character string REG_1 is a description including confidential data, and the alternative character string ALT_1 is a description in which the confidential data is hidden.

Note that the database DB1 includes the record ID1_1, and the record ID1_1 includes the character string REG_1 and the alternative character string ALT_1 associated with the character string REG_1 (see FIG. 2A).

The database DB1 has a function of sending the alternative character string ALT_1 in response to a query specifying the character string REG_1. The database DB1 also has a function of sending the character string REG_1 in response to a query specifying the alternative character string ALT_1.

### [Step S4]

In Step S4, the component 21 queries whether the first token of the line L_n is registered in the database DB2, and obtains the syntax Synt_1 when the token is the reserved word RSVD_1 registered in the database DB2.

The database DB2 includes the record ID2_1, and the record ID2_1 includes the reserved word RSVD_1 and the syntax Synt_1 associated with the reserved word RSVD_1 (see FIG. 2B). The database DB2 has a function of sending the syntax Synt_1 in response to a query specifying the reserved word RSVD_1.

### [Step S5]

In Step S5, the component 21 generates the prompt PT_n and transfers the prompt PT_n to the component 20.

The prompt PT_n includes the line L_n, the syntax Synt_1, and the template sentence Tmpl. The template sentence Tmpl includes the instruction Instr for verifying the line L_n and generating the report sentence REP_n (see FIG. 3C). In the case where the line L_n violates the syntax, the report sentence REP_n includes the annotated line LAno_n (see FIG. 3D). Note that the annotated line LAno_n includes predetermined tags that are inserted to surround a portion that violates the syntax Synt_1.

### [Step S6]

In Step S6, the component 20 generates the report sentence REP_n in accordance with the prompt PT_n by using a large language model and transfers the report sentence REP_n to the component 21.

### [Step S7]

In Step S7, when the report sentence REP_n includes the alternative character string ALT_1, the component 21 replaces the alternative character string ALT_1 with the character string REG_1.

### [Step S8]

In Step S8, the component 21 adds the report sentence REP_n to the report LOG, and the process proceeds to Step S2.

### [Step S9]

In Step S9, the component 21 transfers the report LOG to the component 30.

### [Step S10]

In Step S10, the component 30 receives the report LOG, emphasizes a portion that violates the syntax Synt_1, and provides the user of the data processing system with the resulting report LOG.

Accordingly, for example, a large language model can be used to verify the document DOC written in the programming language Lang that is modified by adding a special function. Moreover, a large language model can be used to verify the document DOC without leaking confidential data. The syntax of a file input to an electronic circuit simulator, for example, can be verified using a large language model. The line L_n that violates the syntax can be extracted and provided from the document DOC. A portion that violates the syntax Synt_1 can be emphasized and provided. Even an inexperienced designer can efficiently verify the document DOC. As a result, a novel data processing method that is highly convenient, useful, or reliable can be provided.

Note that this embodiment can be combined with the other embodiment in this specification as appropriate.

This application is based on Japanese Patent Application Serial No. 2023-195210 filed with Japan Patent Office on Nov. 16, 2023, the entire contents of which are hereby incorporated by reference.

What is claimed is:

1. A data processing system comprising:
a first component;
a second component; and
a third component,
wherein the first component is configured to receive a document and transfer the document to the third component,
wherein the document is written in a programming language,
wherein the first component is configured to receive a report and extract and provide a portion violating syntax of the programming language in the document,
wherein the second component is configured to perform processing using a large language model,
wherein the large language model has learned the programming language,
wherein the second component is configured to generate a report sentence in accordance with a prompt and transfer the report sentence to the third component,
wherein the third component is configured to perform processing using a database,
wherein the database comprises a record,
wherein the record comprises a character string and an alternative character string associated with the character string,
wherein the database is configured to send the alternative character string in response to a query specifying the character string,
wherein the database is configured to send the character string in response to a query specifying the alternative character string,
wherein the third component is configured to sequentially read one line from the document,
wherein the third component is configured to search for whether the read line comprises a character string registered in the database and, when finding the character string, replace the character string of the line with the alternative character string,
wherein the third component is configured to generate the prompt and transfer the prompt to the second component,
wherein the prompt comprises the line and a template sentence,
wherein the template sentence comprises an instruction to verify the line and generate the report sentence,
wherein when the line violates the syntax, the report sentence comprises the line,
wherein the third component is configured to replace the alternative character string included in the report sentence with the character string and then add the report sentence to the report, and
wherein the third component is configured to transfer the report to the first component.

2. A data processing system comprising:
a first component;
a second component; and
a third component,
wherein the first component is configured to receive a document and transfer the document to the third component,
wherein the document is written in a programming language,
wherein the first component is configured to receive a report and extract and provide a portion violating syntax of the programming language in the document,
wherein the second component is configured to perform processing using a large language model,
wherein the large language model has learned the programming language,
wherein the second component is configured to generate a report sentence in accordance with a prompt and transfer the report sentence to the third component,
wherein the third component is configured to perform processing using a first database,
wherein the first database comprises a first record,
wherein the first record comprises a character string and an alternative character string associated with the character string,
wherein the first database is configured to send the alternative character string in response to a query specifying the character string,
wherein the first database is configured to send the character string in response to a query specifying the alternative character string,
wherein the third component is configured to sequentially read one line from the document,
wherein the third component is configured to search for whether the read line comprises a character string registered in the first database and, when finding the character string, replace the character string of the line with the alternative character string,
wherein the third component is configured to perform processing using a second database,
wherein the second database comprises a second record,
wherein the second record comprises a reserved word and the syntax associated with the reserved word,
wherein the second database is configured to send the syntax in response to a query specifying the reserved word,
wherein the third component is configured to extract a first token from the line,
wherein the third component is configured to query whether the first token of the line is registered in the second database and obtain the syntax when the first token is the reserved word,
wherein the third component is configured to generate the prompt and transfer the prompt to the second component,
wherein the prompt comprises the line, the syntax, and a template sentence,
wherein the template sentence comprises an instruction to verify the line by using the syntax and generate the report sentence,
wherein when the line violates the syntax, the report sentence comprises the line,
wherein the third component is configured to replace the alternative character string included in the report sentence with the character string and then add the report sentence to the report, and
wherein the third component is configured to transfer the report to the first component.

3. The data processing system according to claim 2,
wherein the first component is configured to receive the report and emphasize a portion violating the syntax in the document,
wherein the template sentence comprises the instruction to verify the line by using the syntax and generate the report sentence,
wherein the report sentence comprises an annotated line, and
wherein the annotated line comprises the line in which predetermined tags are inserted to surround the portion violating the syntax.

4. A data processing method comprising:
a first step;
a second step;
a third step;
a fourth step;
a fifth step;
a sixth step;
a seventh step;
an eighth step; and
a ninth step,
wherein in the first step, a first component receives a document and transfers the document to a second component,
wherein the document is written in a programming language,
wherein in the second step, the second component sequentially reads one line from the document,
wherein a process proceeds to the third step when a last line of the document has not yet been read out; otherwise, the process proceeds to the eighth step,
wherein in the third step, the second component searches for whether the one line comprises a predetermined character string registered in a database,
wherein when the predetermined character string registered in the database is found, an alternative character string is obtained and the character string of the line is replaced with the alternative character string,
wherein the database comprises a record, and the record comprises the character string and the alternative character string associated with the character string,
wherein the database is configured to send the alternative character string in response to a query specifying the character string, and send the character string in response to a query specifying the alternative character string,
wherein in the fourth step, the second component generates a prompt and transfers the prompt to a third component,
wherein the prompt comprises the line and a template sentence,
wherein the template sentence comprises an instruction to verify the line and generate a report sentence,
wherein when the line violates syntax, the report sentence comprises the line violating the syntax,
wherein in the fifth step, the third component generates the report sentence in accordance with the prompt by using a large language model that has learned the programming language, and transfers the report sentence to the second component,
wherein in the sixth step, when the report sentence comprises the alternative character string, the second component replaces the alternative character string with the character string,
wherein in the seventh step, the second component adds the report sentence to a report, and the process proceeds to the second step,
wherein in the eighth step, the second component transfers the report to the first component, and
wherein in the ninth step, the first component receives and provides the report.

5. A data processing method comprising:
a first step;
a second step;
a third step;
a fourth step;
a fifth step;
a sixth step;
a seventh step;
an eighth step;
a ninth step; and
a tenth step,
wherein in the first step, a first component receives a document and transfers the document to a second component,
wherein the document is written in a programming language,
wherein in the second step, the second component sequentially reads one line from the document,
wherein a process proceeds to the third step when a last line of the document has not yet been read out; otherwise, the process proceeds to the ninth step,
wherein in the third step, the second component searches for whether the one line comprises a predetermined character string registered in a first database,
wherein when the predetermined character string registered in the first database is found, an alternative character string is obtained and the character string of the line is replaced with the alternative character string,
wherein the first database comprises a first record, and the first record comprises the character string and the alternative character string associated with the character string,
wherein the first database is configured to send the alternative character string in response to a query specifying the character string, and send the character string in response to a query specifying the alternative character string,
wherein in the fourth step, the second component queries whether a first token of the line is registered in a second database, and obtains syntax when the first token is a reserved word registered in the second database,
wherein the second database comprises a second record, and the second record comprises the reserved word and the syntax associated with the reserved word,
wherein the second database is configured to send the syntax in response to a query specifying the reserved word,
wherein in the fifth step, the second component generates a prompt and transfers the prompt to a third component,
wherein the prompt comprises the line, the syntax, and a template sentence,
wherein the template sentence comprises an instruction to verify the line and generate a report sentence,
wherein when the line violates the syntax, the report sentence comprises an annotated line,
wherein the annotated line comprises predetermined tags inserted to surround a portion violating the syntax,
wherein in the sixth step, the third component generates the report sentence in accordance with the prompt by using a large language model, and transfers the report sentence to the second component,
wherein in the seventh step, when the report sentence comprises the alternative character string, the second component replaces the alternative character string with the character string,
wherein in the eighth step, the second component adds the report sentence to a report, and the process proceeds to the second step,
wherein in the ninth step, the second component transfers the report to the first component, and
wherein in the tenth step, the first component receives the report, emphasizes the portion violating the syntax, and provides the report.
